(19) United States
(12) Patent Application Publication
(10) Pub. No.: US 2002/0011188 A1
(43) Pub. Date: Jan. 31, 2002

(54) Glass grip

(76) Inventors: John Lamb, Oceanside, CA (US); Steve Anaya, Laguna Beach, CA (US)

Correspondence Address: John Charles Lamb, PO Box 571, Dana Point, CA, 92629, US

(21) Appl. No.: 09/854,231

(22) Filed: May 11, 2001

Related U.S. Application Data
(60) Provisional application No. 60/204,012, filed on May 15, 2000.

(51) Int. Cl. C08L 1/10; C09D 101/10; C09J 101/10; C04B 24/34; C04B 28/26

(52) U.S. Cl. 106/610; 106/162.7

(57) ABSTRACT

A friction anti-slip material which may be coated to the patterned surface of a organic or inorganic material or substrate which permits the visual observation of such pattern. A first and/or second coating of transparent binder adherently bond a multitude of minute transparent post consumer glass particles uniformly dispersed over the upper surface of a substrate or organic or inorganic material that is directly applied or attached to a pressure sensitive adhesive. The glass particles may be glass spheres or fragments obtained by fracturing larger particles of glass. This present invention is particularly suited for applying to the surface of skateboards, particularly those which have ornamental surfaces which the owner desire not to obscure

### BACKGROUND OF THE INVENTION

1. Field of the Invention

The present invention relates to a transparent friction material formed by bonding transparent glass particles with a transparent binder material to the surface of 1 Wood, organic and inorganic materials which may have transparent pressure-sensitive adhesive on the opposite surface.

2. Prior Art

Skate boarding is a pastime which is rapidly gaining popularity both in the United States and in many foreign countries. The skate board has evolved from a very simple device comprising roller skate wheels fastened to a board to exotic and aesthetically pleasing vehicles designed by engineers and decorated by artists or skilled designers-to provide engineering and artistic marvels, many times costing several hundred dollars each or more. In fact, even the casual skate boarder has a sizable investment in his vehicle which is frequently exotically ornamented by the manufacturer on the bottom surface which is not intended to bear the feet of the user.

It is generally recognized by most skate boarders that it its desirable to have a frictional top or foot-bearing surface of the skate board to facilitate maneuvering and prevent slipping. Many commercially available friction surface sheet materials have been employed for this purpose. A particular useful sheet material is that manufactured and sold on the open market place is griptape. While such a friction surface sheet material provides an adequate degree of frictional resistance, it is only available in embodiments which obscure any decoration or art work which may be present on the surface to which it is applied. The present invention provides a friction material which provides superior frictional resistance yet permits visual observation there through with little or no obscuring any surface decoration on the skate board.

3. Application

The friction material may be applied by mixing part (A) water base lacquer with the recycled glass fragments at a ratio of 7:3 glass to lacquer.

Thereafter the friction material may be applied to wood, organic or inorganic surfaces by means of brushing or rolling or spraying. The glass particles may also be applied to the make coating by any of a number of known methods such as the methods known in the abrasive making art. The preferred method of coating the glass particles on the backing layer is by drop coating wherein the glass particles are uniformly distributed and permitted to fall through the air onto the freshly coated surface of the backing. Thereafter the make coating may be first cured or the size coating may be applied immediately and both coatings cured simultaneously.

4. Components

Part A) Glass Oxide Cas 65997-17

Amorphous Silicate (Recycled Glass) 100% post consumer

Part B) High Solid Water-based Lacquer (Poly)

code identification 645-0065

Product class: Waterborne Coating

### SUMMERY OF THE PRESENT INVENTION

The present invention is a friction material which is capable of being directly coated or adhesively attached to the surface of a substrate such as the foot-bearing surface of a skate board which may contain thereon a surface decoration without significantly obscuring the decoration, when attached or directly coated.

The friction material of the present invention comprises a multitude of glass particles screened no larger than twenty mesh grit and no smaller than eighty mesh grit.

While the friction material has been suggested for use on skate boards, it is intended for use on any other substrate to which it may be applied, whether or not the transparency feature would be a benefit. Examples of use situations where the transparency would be a benefit where the friction surface of the present invention may be used include painted surfaces where the user does not want to obscure the painted surface being coated, for example on the tip portion of a fender of a boat trailer, where that portion is used to step onto the trailer, on diving boards, surf boards, and the like.

What is claimed is:

1. A friction material capable of being adherently bonded or coated to the surface of wood or other organic or inorganic materials which may have an ornamental pattern on said surfaces and which material, when applied to said surfaces, permits visual observation of said patters, comprising:
(1) A coating of a tough transparent binder material useful for pedestrian traffic.
(2) A multitude of minute recycled glass particles capable of withstanding pedestrian traffic without significant fracture uniformly distributed over said upper majors surface and firmly, adherantly bonded there by said transparent binder material with a combined thickness which is sufficient to substantially prevent particle loss under pedestrian use. The tops of said glass particles projecting above the exposed surface of said second coating to provide a friction surface.
(3) The friction material of claim 2 wherein said glass particles are fractured glass particles having irregular edges.
(4) The friction material of claim 2 wherein said glass particles are glass beads having spherical shapes.
(5) The transparent binder material of claim 2 wherein said transparent binder material is a water base lacquer binder.
